(19) United States
(12) Patent Application Publication
(10) Pub. No.: US 2005/0134060 A1
(43) Pub. Date: Jun. 23, 2005

(54) Lock

(75) Inventor: Chiang-Lin Hsueh, Kaohsiung Hsien (TW)

Correspondence Address: BACON & THOMAS, PLLC, 625 SLATERS LANE, FOURTH FLOOR, ALEXANDRIA, VA, 22314, US

(73) Assignee: Taiwn Fu Hsing Industrial Co., Ltd., Kaohsiung Hsien (TW)

(21) Appl. No.: 10/761,236

(22) Filed: Jan. 22, 2004

(30) Foreign Application Priority Data
Dec. 22, 2003 (TW) 92222432

(51) Int. Cl. E05B 3/00

(52) U.S. Cl. 292/336.3

(57) ABSTRACT

A lock includes a handle assembly, a latch housing, and an adaptor plate. The handle assembly includes a rose liner and a spindle. The latch housing includes two positioning holes and an actuating wheel. A distance between two positioning holes of the rose liner is not equal to that between the positioning posts of the rose liner. The actuating wheel has a non-circular hole. The adaptor plate includes an axial hole, two positioning holes, two pegs and at least one leg. The spindle extends through the axial hole of the adaptor plate and the non-circular hole of the actuating wheel. The positioning posts of the rose liner respectively extend through the positioning holes of the adaptor plate. The pegs respectively extend through the positioning holes of the latch housing. The leg extends from the adaptor plate and abuts against the rose liner, thereby retaining the adaptor plate in place.

### BACKGROUND OF THE INVENTION

1. Field of the Invention

The present invention relates to a lock. In particular, the present invention relates to a lock that allows a handle assembly to be used with latch housings with various specifications through the use of an adaptor plate.

2. Description of Related Art

FIG. 1 of the drawings illustrates a conventional lock including a first handle assembly 1, a second handle assembly 2, and a latch assembly. The first handle assembly 1 includes a first rose liner 11 having two positioning posts 12 extending from a side of the first rose liner 11. The first handle assembly 1 further includes a spindle 13. The latch assembly includes a latch housing 3 having a first positioning hole 31, a second positioning hole 32, and an actuating wheel 33. In assembly, the housing 3 is mounted into a receiving hole (not labeled) in a door 9, with the first positioning hole 31, the second positioning hole 32, and a non-circular hole 331 of the actuating wheel 33 being located in a mounting hole 91 of the door 9. Next, the positioning posts 12 of the first rose liner 11 are respectively extended through the first positioning hole 31 and the second positioning hole 32 and through two positioning holes 22 in a second rose liner 21 of the second handle assembly 2. Meanwhile, the spindle 13 is extended through the non-circular hole 331 of the actuating wheel 33, thereby rapidly mounting the lock to the door 9. However, the positioning posts 12 of a certain specification can only be used with a latch housing 3 having correspondingly located first and second positioning holes 31 and 32. Namely, the first handle assembly 1 cannot be used with the latch housing 3 in a case that the distance between the first positioning hole 31 and the second positioning hole 32 is not equal to that between the positioning posts 12.

FIG. 2 of the drawings illustrates another conventional lock including a first handle assembly 1, a second handle assembly 2, and a latch assembly, which are substantially the same as those of the lock in FIG. 1. Further, the lock in FIG. 2 includes a reinforcing plate 8 having an axial hole 81, two pegs 82 extending from a side of the reinforcing plate 8, and a plurality of grooves 83. The respective peg 82 is at an angle with the respective adjacent groove 83. In assembly, the positioning posts 12 of the first rose liner 11 are extended through two of the grooves 83, and the pegs 82 are extended through the positioning holes 31 and 32 of the latch housing 3. Thus, the first handle assembly 1 can be attached to the latch housing 3 with the handle of either handle assembly 1, 2 being located in a position at 45 degrees with respect to a longitudinal direction of the latch housing 3, assisting disabled, aged, or children in easily opening the door 9 without changing the handle assemblies 1 and 2 and the latch assembly. Nevertheless, the distance between the pegs 82 of the reinforcing plate 8 has to be equal to that between the positioning holes 31 and 32 of the latch housing 3. Further, the reinforcing plate 8 is not reliably supported and abuts against an elastic means 14. Thus, the reinforcing plate 8 is apt to wobble and adversely affects smooth rotation of the first handle assembly 1.

### OBJECTS OF THE INVENTION

An object of the present invention is to provide a lock that allows a handle assembly to be used with latch housings with various specifications (i.e., various distances between the positioning holes), increasing the assembling tolerance and increasing the application range while assembling the handle assembly and the latch housing.

Another object of the present invention is to provide a lock with improved assembling reliability and improved assembling stability.

### SUMMARY OF THE INVENTION

In accordance with an aspect of the invention, a lock includes a handle assembly, a latch housing, and an adaptor plate. The handle assembly includes a rose liner and a spindle, the rose liner including two positioning posts. The latch housing includes two positioning holes and an actuating wheel. A distance between the positioning holes is not equal to that between the positioning posts of the rose liner. The actuating wheel has a non-circular hole.

The adaptor plate includes an axial hole, two positioning holes, two pegs and at least one leg. The spindle extends through the axial hole of the adaptor plate and the non-circular hole of the actuating wheel. A distance between the positioning holes of the adaptor plate is equal to the distance between the positioning posts of the rose liner, allowing the positioning posts of the rose liner to respectively extend through the positioning holes of the adaptor plate. A distance between the pegs of the adaptor plate is equal to the distance between the positioning holes of the latch housing, allowing the pegs to respectively extend through the positioning holes of the latch housing. Through use of adaptor plates of various specifications, a handle assembly of a certain specification can be used with latch housings with various specifications (i.e., various distances between the positioning holes of the latch housings).

The leg extends from the adaptor plate and abuts against the rose liner, thereby retaining the adaptor plate in place. Thus, improved assembling reliability and improved stability are provided.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of a conventional lock;

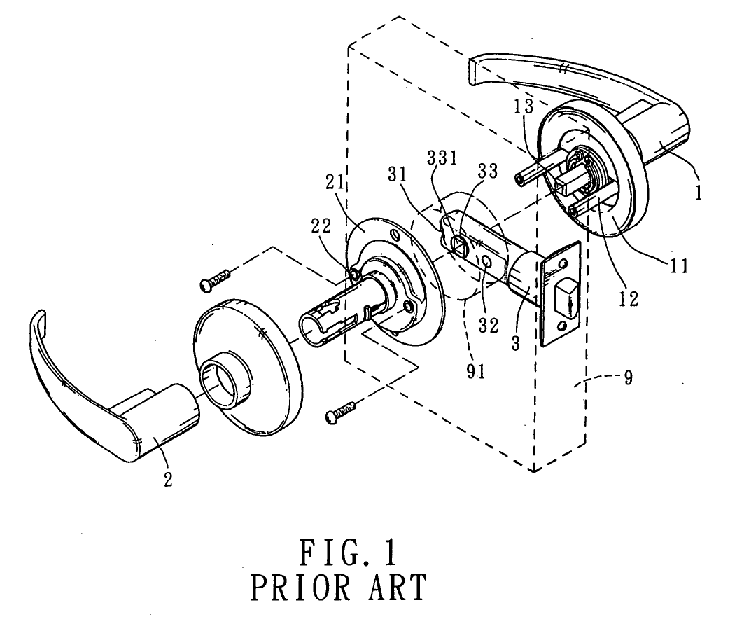

FIG. 2 is an exploded perspective view of another conventional lock;

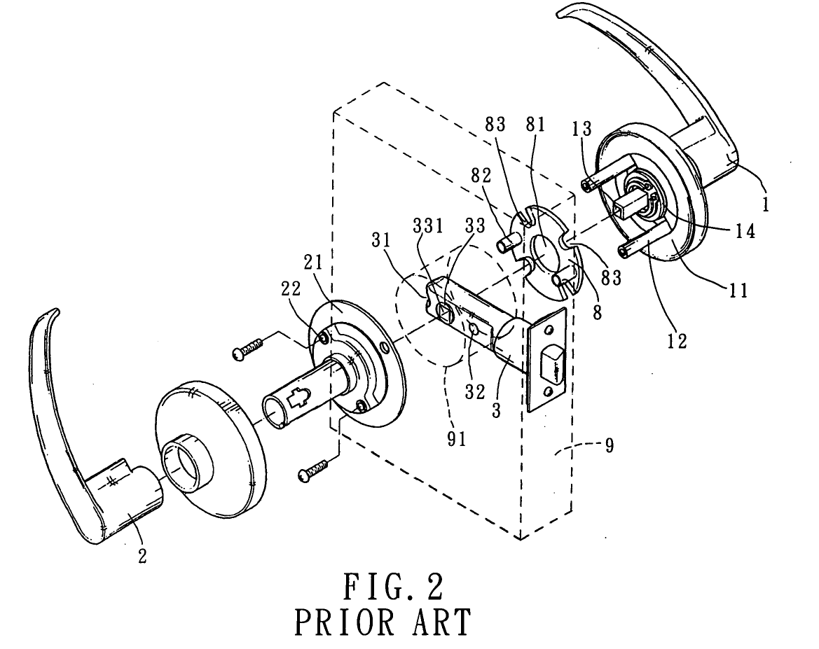

FIG. 3 is an exploded perspective view of a lock in accordance with the present invention;

FIG. 4 is a top view of the lock in accordance with the present invention;

FIG. 5 is a sectional view taken along plane 5-5 in FIG. 4; and

FIG. 6 is a sectional view similar to FIG. 5, illustrating a modified embodiment of a reinforcing plate of the lock in accordance with the present invention.

### DETAILED DESCRIPTION OF THE PREFERRED EMBODIMENTS

Preferred embodiments of the present invention are now to be described hereinafter in detail, in which the same reference numerals are used in the preferred embodiments for the same parts as those in the prior art to avoid redundant description.

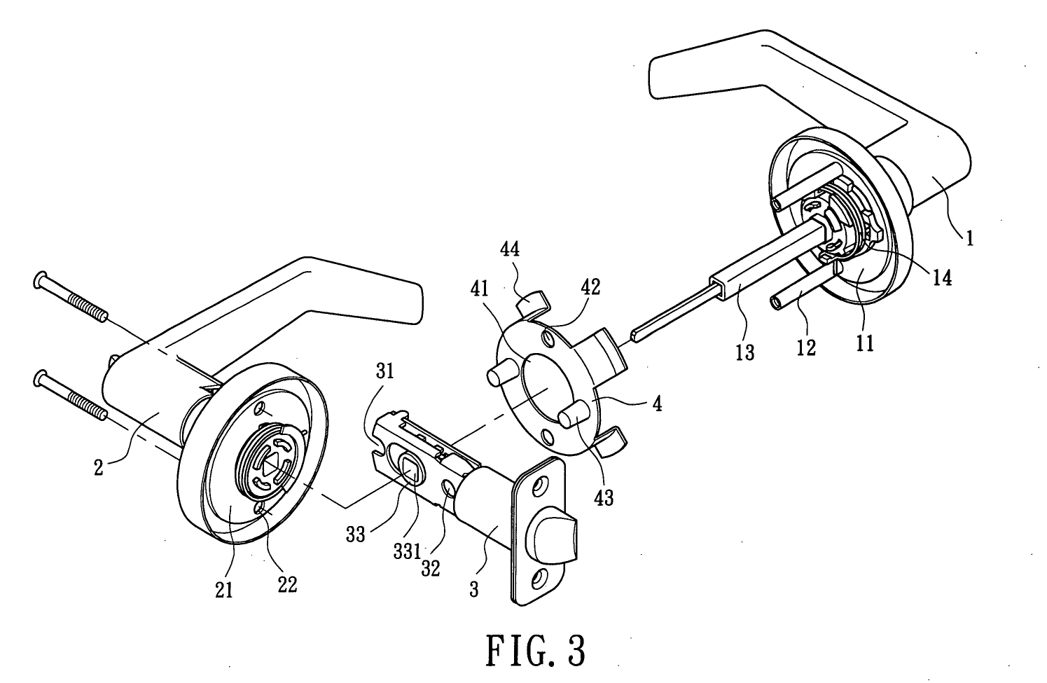

Referring to FIGS. 3 through 5, a lock in accordance with the present invention includes a first handle assembly 1, a second handle assembly 2, an adaptor plate 4, and a latch assembly. The first handle assembly 1 includes a first rose liner 11 having two positioning posts 12 extending from a side of the first rose liner 11. The first handle assembly 1 further includes a spindle 13 and an elastic means 14. The second handle assembly 2 includes a second rose liner 21 having two positioning holes 22 through which the positioning posts 12 respectively extend.

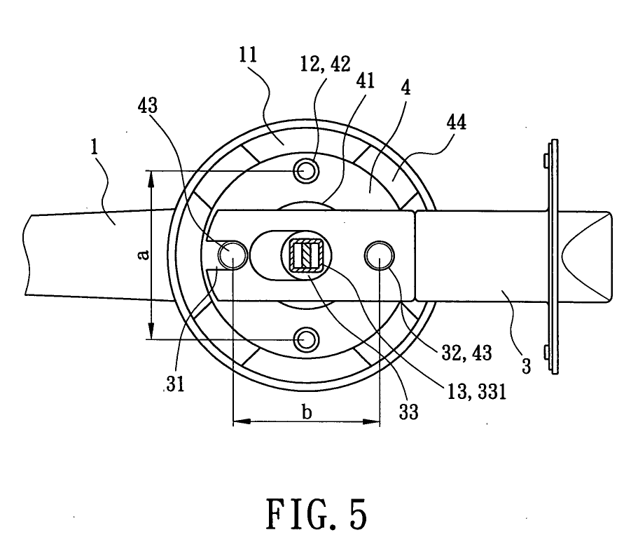

The latch assembly includes a latch housing 3 having a first positioning hole 31, a second positioning hole 32, and an actuating wheel 33. Each of the first and second positioning holes 31 and 32 is a through-hole or a hole having an open side. Referring to FIG. 5, a distance “b” between the centers of the first and second positioning holes 31 and 32 is smaller (or greater, when desired) than a distance “a” between the centers of the positioning posts 12.

The adaptor plate 4 includes an axial hole 41, two positioning holes 42, two pegs 43 formed on a side of the adaptor plate 4, and a plurality of legs 44. The spindle 13 extends through the axial hole 41 of the adaptor plate 4. A distance “a” between the centers of the positioning holes 42 of the adaptor plate 4 is equal to that between the centers of the positioning posts 12. Each positioning hole 42 is a through-hole or a hole having an open side. The respective peg 43 is at an angle (preferably 90 degrees) with the respective positioning groove 42. A distance “b” between the centers of the pegs 43 is equal to that between the centers of the positioning holes 31 and 32 of the latch housing 3. Each leg 44 extends toward the first rose liner 11 and abuts against the first rose liner 11.

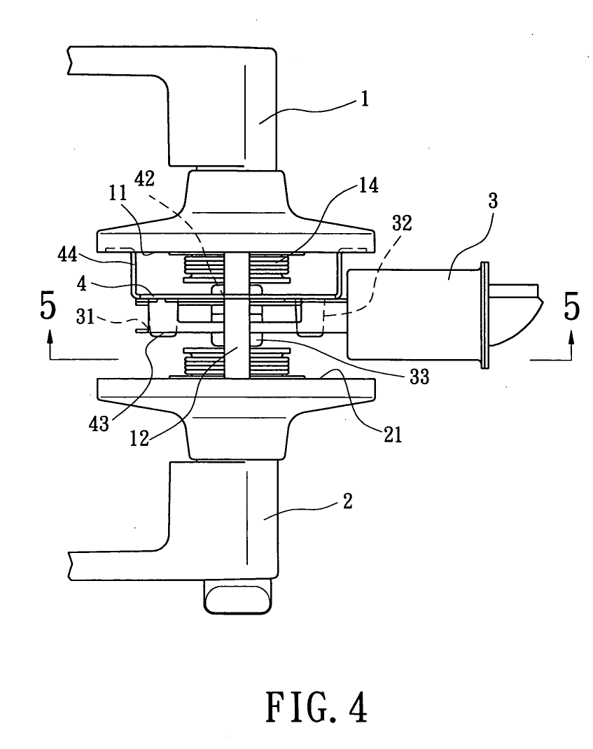

Referring to FIGS. 4 and 5, the adaptor plate 4 is useful when engaging the first handle assembly 1 with the latch housing 3 in a case that a distance between the centers of the positioning holes 31 and 32 that is not equal to the distance between the centers of the positioning rods 12. The positioning posts 12 of the first rose liner 11 are respectively extended through the positioning holes 42 of the adaptor plate 4, and the spindle 13 is extended through the axial hole 41 of the adaptor plate 4, with the legs 44 pressing abutting against the first rose liner 11. Thus, the adaptor plate 4 does not contact the elastic means 14 and thus would not interfere with operation of the elastic means 14. Next, the pegs 43 of the adaptor plate 4 are respectively extended through the first positioning hole 31 and the second positioning hole 32 of the latch housing 3. Thus, the handle assembly having a certain specification (i.e., a fixed distance between the positioning posts 12 of the inside rose liner 11) can be used with latch housings 3 with various distances between the positioning holes 31 and 32 through the use of the adaptor plate 4. A manufacturer may produce adaptor plates 4 of various specifications for latch housings having various specifications (i.e., various distances between the positioning holes 31 and 32). The overall cost for the molds for manufacturing the adaptor plates 4 is much lower than the cost for manufacturing handle assemblies of various specifications and latch housings of various specifications.

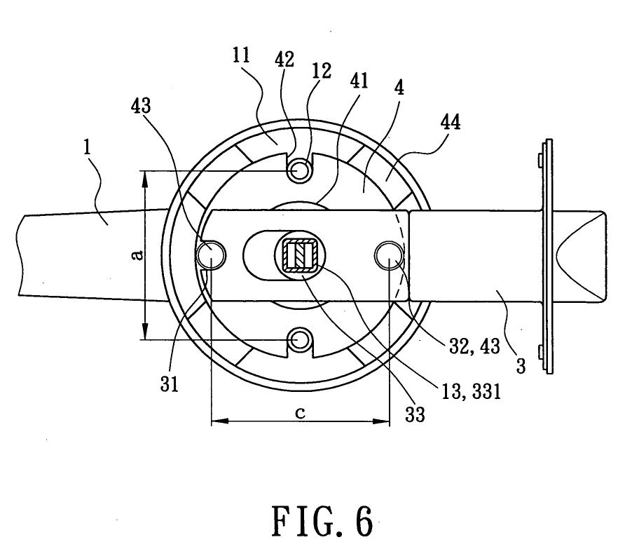

FIG. 6 of the drawings illustrates a modified embodiment of the adaptor plate 4. In this embodiment, in a case that the distance “a” between the centers of the positioning posts 12 of the first handle assembly 1 is smaller that the distance “c” between the centers of the first and second positioning holes 31 and 32 of the latch housing 3. In this case, an adaptor plate 4 including two pegs 43 whose centers having a distance “c” therebetween can be used. Thus, the first handle assembly 1 can be rapidly coupled to the latch housing 3 through the use of the adaptor plate 4. The positioning hole 42 of the adaptor plate 4 can be U-shaped. Similar to the above embodiment, the assembling tolerance and application range for assembling the first handle assembly 1 and the latch assembly are increased, and the cost for assembling and manufacturing is reduced.

Still referring to FIGS. 5 and 6, the legs 44 of the adaptor plate 4 can be fixed to the first rose liner 11 by snapping members, screws, welding, or heat pressing, further improving the assembling reliability and the assembling stability.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

1. A lock comprising:
a handle assembly including a rose liner and a spindle, the rose liner including two positioning posts;
a latch housing including two positioning holes and an actuating wheel, a distance between the positioning holes being not equal to that between the positioning posts of the rose liner, the actuating wheel having a non-circular hole; and
an adaptor plate including an axial hole, two positioning holes, two pegs and at least one leg, the spindle extending through the axial hole of the adaptor plate and the non-circular hole of the actuating wheel, a distance between the positioning holes of the adaptor plate being equal to the distance between the positioning posts of the rose liner, allowing the positioning posts of the rose liner to respectively extend through the positioning holes of the adaptor plate, a distance between the pegs of the adaptor plate being equal to the distance between the positioning holes of the latch housing, allowing the pegs to respectively extend through the positioning holes of the latch housing, said at least one leg extending from the adaptor plate and abutting against the rose liner, thereby retaining the adaptor plate in place.

2. The lock as claimed in claim 1, further including another handle assembly including another rose liner having two positioning holes through which the positioning posts of the rose liner of the handle assembly respectively extend.

3. The lock as claimed in claim 1, wherein the distance between the positioning holes of the latch housing is smaller than the distance between the positioning posts of the rose liner.

4. The lock as claimed in claim 1, wherein the distance between the positioning holes of the latch housing is greater than the distance between the positioning posts of the rose liner.

5. The lock as claimed in claim 1, wherein each said positioning hole of the adaptor plate is a through-hole.

6. The lock as claimed in claim 1, wherein each said positioning hole of the latch housing is a through-hole.

7. The lock as claimed in claim 1, wherein each said positioning hole of the adaptor plate has an open side.

8. The lock as claimed in claim 1, wherein each said positioning hole of the latch housing has an open side.

9. The lock as claimed in claim 1, wherein said at least one leg is fixed to the rose liner by one of snapping, screwing, welding, and heat pressing.

10. The lock as claimed in claim 1, wherein the respective positioning hole of the adaptor plate is at 90 degrees with the respective peg of the adaptor plate.
